(19) United States
(12) Patent Application Publication
(10) Pub. No.: US 2025/0285461 A1
(43) Pub. Date: Sep. 11, 2025

(54) SYSTEM AND METHODS FOR DETECTING ALTERED DOCUMENTS

(71) Applicant: OPEN TEXT INC., Wilmington, DE (US)

(72) Inventors: Ravi Kumar Jammikunta, Hyderabad (IN); Satish Puppala, Hyderabad (IN)

(73) Assignee: OPEN TEXT INC., Wilmington, DE (US)

(21) Appl. No.: 19/007,484

(22) Filed: Jan. 1, 2025

(30) Foreign Application Priority Data
Mar. 6, 2024 (IN) 202411015851

(51) Int. Cl. G06V 30/41; G06F 21/30; G06K 19/06; G06V 20/00

(52) U.S. Cl. CPC G06V 30/41; G06F 21/30; G06K 19/06037; G06V 20/95

(57) ABSTRACT

Many documents, whether hardcopy or softcopy, require authentication for a particular use. Documents are often copied but knowing whether the contents of a document, even a copy of the document, have been altered can still be critical to the particular use. In one embodiment, a document's content is encoded with a symbolic representation, such as one or more Quick Response (QR) codes, derived from the document's content. Subsequent scanning of the document retrieves the document's content and the symbolic representation. The retrieved document's contents are then used to generate a symbolic representation of the content and compared to the content encoded in the symbolic representation. If the two match, the document has not been altered.

### CROSS REFERENCE TO RELATED APPLICATIONS

This application claims priority to India patent application No. 202411015851, filed Mar. 6, 2024, the entire contents of which are incorporated herein by reference.

### FIELD OF THE DISCLOSURE

The invention relates generally to systems and methods for detecting if the content of a document has been altered.

### BACKGROUND

The modern world relies more and more on digital documents; however, paper documents remain an important aspect of modern life. Documents, such as certificates, bills, receipts, bank statements, contracts, etc., are often presented in paper form by one party to another party. For example, an individual that recently moved to a new residence may present a lease agreement or electric bill to someone else as proof of their new address. In another example, an employer may require current or prospective employees to have completed a particular training course. Evidence that the course was successfully completed is provided by a paper certificate. Similarly, electronic or “soft” documents are ubiquitous. As one of countless examples, a loan applicant may create a scan document of a paystub as part of a loan application process. Other soft documents may only exist in electronic form, such as a receipt from an online business.

With readily available scanners and cameras, image editing software, and printers, little skill is required to create realistic but altered documents. While official documents, such as bank notes and drivers' licenses, often have anti-counterfeiting elements (e.g., color-shifting ink, watermarks, holograms, etc.), the majority of documents created by individuals and companies either have no such elements or the elements that are present, such as text or images used on letterhead, are easily reproduced. Even documents with anti-counterfeiting elements, such as holograms, are often copied and the copies relied upon as being authentic.

Even if policy, or suspicion, justifies contacting an issuing party regarding the authenticity of a document, the person seeking verification has the burdensome task of identifying the entity to call, calling and spending time on hold and being routed to a person who is able to provide the validation, etc. Even if a connection is made with a person who has the ability to verify the authenticity of the document, such a request may be refused due to privacy or security concerns.

### SUMMARY

Reliance on documents, even rather mundane documents (e.g., lease agreements, receipts, etc.) can be important. Often a third party will rely on a document issued by one party regarding a second party in order to attest to some attribute of the second party. Determining if a document is authentic or not, such as due to an alteration, without requiring a separate entity to verify the document, promotes confidence in authentic documents and readily identifies altered documents.

These and other needs are addressed by the various embodiments and configurations of the present invention. The present invention can provide a number of advantages depending on the particular configuration. These and other advantages will be apparent from the disclosure of the invention(s) contained herein.

In one embodiment, documents are generated to include an indicium. The indicium is determined by generating a unique code from the document itself. Validation, including validation of a copy or electronic version of the document, may be performed by utilizing the same or similar encoding technique utilized to generate the indicium. An alteration to the document would result in a generated indicium that does not match the indicium based on the original document and applied thereto.

In another embodiment, the document content (e.g., text, numbers, special characters, Unicode characters, etc.) of the document is encoded. For example, numerical values (e.g., ASCII, EBCIC, Unicode, etc.) for characters may be utilized for encoding. Additionally or alternatively, the document content is encoded with the corresponding location (e.g., x-y coordinates, line number, paragraph number, etc.) of the document content. The resulting numerical values may then be hashed, such as via a SHA-512 hash. The hash may then be encrypted and the resulting encrypted used to generate at least a portion of the indicium. In another embodiment, identification of the encoding methodology (e.g., application or algorithm, version number, etc.) is utilized as a portion of the indicium.

In another embodiment, one or more graphical encodings are utilized to encode the hash, encrypted hash, and/or encoding methodology. As a further embodiment, the graphical encoding comprises one or more Quick Response (QR) codes. It should be appreciated that other machine-readable graphical encodings (e.g., bar codes, a data matrix, PDF417, Aztec code, JAB code, Microsoft Tag, etc.) may be utilized in addition to or instead of QR codes. Graphical encodings that utilize color (e.g., Microsoft Tag) require the use of color imaging and printing as the use of black and white imaging or printing would result in lost data. In another embodiment, the indicium comprises a first QR code that encodes the hash, a second QR code that encodes the encrypted hash, and a third QR code that encodes the encoding methodology. In a further embodiment, two or more of the first, second, and third QR codes are skewed and arranged as facets of a single graphical element, such as to form a two-dimensional rendering of a cube.

In some aspects, the techniques described herein relate to a method of determining document alteration, including: imaging a document, the document including document content and graphically-encoded document information; decoding the graphically-encoded document information to obtain reported textually-encoded document information; encoding the document content to produce derived textually-encoded document information; and upon determining that the reported textually-encoded document information matches the derived textually-encoded document information, identifying the document as unaltered, and upon determining that the reported textually-encoded document information differs from the derived textually-encoded document information, identifying the document as altered.

In some aspects, the techniques described herein relate to a method, wherein the graphically-encoded document information includes a machine-readable set of geometric elements that graphically encode the reported textually-encoded document information.

In some aspects, the techniques described herein relate to a method, wherein the reported textually-encoded document information encodes at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

In some aspects, the techniques described herein relate to a method, wherein encoding the document content to produce the derived textually-encoded document information includes encoding at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

In some aspects, the techniques described herein relate to a method wherein the at least one of characters of the document content includes a Unicode character.

In some aspects, the techniques described herein relate to a method wherein the at least one character of the document content includes a Unicode character.

In some aspects, the techniques described herein relate to a method, wherein the graphically-encoded document information includes a first Quick Response (QR) code.

In some aspects, the techniques described herein relate to a method, wherein: the graphically-encoded document information further includes a second Quick Response (QR) code and a third Quick Response (QR) code; and wherein the second QR code includes an encoded hash of the first QR code; and wherein the third QR code includes an identifier of an encoding method used to generate the first QR code from the document content.

In some aspects, the techniques described herein relate to a method, wherein: the graphically-encoded document information includes a two-dimensional rendering of a cube including a first facet, a second facet, and a third facet; the first facet includes a skewed image of the first QR code; the second facet includes a skewed image of the second QR code; and the third facet includes a skewed image of the third QR code.

In some aspects, the techniques described herein relate to a method, wherein the document is a physical document.

In some aspects, the techniques described herein relate to a system, including: a microprocessor; and a computer readable medium, coupled with the microprocessor and including microprocessor readable and executable instructions that, when executed by the microprocessor, cause the microprocessor to: access an image of a document captured by a camera, the document including document content and graphically-encoded document information; decode the graphically-encoded document information to obtain reported textually-encoded document information; encode the document content to produce derived textually-encoded document information; and upon determining that the reported textually-encoded document information matches the derived textually-encoded document information, identify the document as unaltered, and upon determining that the reported textually-encoded document information differs from the derived textually-encoded document information, identify the document as altered.

In some aspects, the techniques described herein relate to a system, wherein the graphically-encoded document information includes a machine-readable set of geometric elements that graphically encode the reported textually-encoded document information.

In some aspects, the techniques described herein relate to a system, wherein the reported textually-encoded document information encodes at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

In some aspects, the techniques described herein relate to a system, wherein the instructions to cause the microprocessor to encode the document content to produce the derived textually-encoded document information includes instructions to cause the microprocessor to encode at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

In some aspects, the techniques described herein relate to a system, wherein the at least one character of the document content includes a Unicode character.

In some aspects, the techniques described herein relate to a system, wherein the graphically-encoded document information includes a first Quick Response (QR) code.

In some aspects, the techniques described herein relate to a system, wherein: the graphically-encoded document information further includes a second Quick Response (QR) code and a third Quick Response (QR) code; and wherein the second QR code includes an encoded hash of the first QR code; and wherein the third QR code includes an identifier of an encoding method used to generate the first QR code from the document content.

In some aspects, the techniques described herein relate to a system, wherein: the graphically-encoded document information includes a two-dimensional rendering of a cube including a first facet, a second facet, and a third facet; the first facet includes a skewed image of the first QR code; the second facet includes a skewed image of the second QR code; and the third facet includes a skewed image of the third QR code.

In some aspects, the techniques described herein relate to a system, wherein the document is a physical document.

In some aspects, the techniques described herein relate to a non-transient computer readable medium having stored thereon instructions that cause a processor to execute a method, the method including: accessing an image of a document, the document including document content and graphically-encoded document information; decoding the graphically-encoded document information to obtain reported textually-encoded document information; encoding the document content to produce derived textually-encoded document information; and upon determining that the reported textually-encoded document information matches the derived textually-encoded document information, identifying the document as unaltered, and upon determining that the reported textually-encoded document information differs from the derived textually-encoded document information, identifying the document as altered.

In some aspects, the techniques described herein relate to a non-transient computer readable medium, wherein accessing the image of the document includes receiving the image of the document from a camera.

In some aspects, the techniques described herein relate to a method of document encoding, comprising receiving a document; generating a document hash code based on first document information and using a hash function; generating a first Quick Response (QR) code based on the document hash code; generating a unique identifier based on second document information and using a unique identifier generating function; generating an encrypted hash code based on the unique identifier and the document hash code using an encryption function; generating a second QR code based on document version information; and generating a third QR code based on the encrypted hash code.

In some aspects, the techniques described herein relate to a method wherein the first document information comprises document attributes, the document attributes comprising document text and position of the document text.

In some aspects, the techniques described herein relate to a method wherein the first document information comprises a first set of document attributes and the second document information comprises a second set of document attributes different than the first set of document attributes.

In some aspects, the techniques described herein relate to a method wherein the document version information identifies the hash function, the unique identifier generating function, and the encryption function.

In some aspects, the techniques described herein relate to a method comprising: generating a graphic representation based on the first QR code, the second QR code, and the third QR code; and encoding the document with the graphic representation.

In some aspects, the techniques described herein relate to a method wherein the graphic representation comprises a rendering of a cube comprising a first surface comprising the first QR code, a second surface comprising the second QR code; and a third surface comprising the third QR code.

In some aspects, the techniques described herein relate to a method wherein comprising: validating the document based on the encoded graphic representation, comprising: extracting the second QR code from the second surface of the cube; regenerating the document version information from the second QR code comprising: identifying a candidate hash function, a candidate unique identifier generating function, and a candidate encryption function; extracting the first QR code from the first surface of the cube; generating a candidate hash code from the extracted first QR code; regenerating the document hash code based on the first document information and using the candidate hash function; extracting the third QR code from the third surface of the cube; generating a candidate encryption hash code from the extracted third QR code; regenerating the unique identifier based on the second document information and the candidate unique identifier generating function; and regenerating an encrypted hash code based on the regenerated unique identifier and the regenerated document hash code using the candidate encryption function; wherein validating the document is based on a comparison of the candidate hash code and the regenerated hash code and a comparison of the candidate encryption hash code and the regenerated encryption hash code.

In some aspects, the techniques described herein relate to a system for document encoding, comprising: a microprocessor; and a computer readable medium, coupled with the microprocessor and comprising microprocessor readable and executable instructions that, when executed by the microprocessor, cause the microprocessor to: receive a document; generate a document hash code based on first document information and using a hash function; generate a first Quick Response (QR) code based on the document hash code; generate a unique identifier based on second document information and using a unique identifier generating function; generate an encrypted hash code based on the unique identifier and the document hash code using an encryption function; generate a second QR code based on document version information; and generate a third QR code based on the encrypted hash code.

In some aspects, the techniques described herein relate to a system wherein the first document information comprises document attributes, the document attributes comprising document text and position of the document text.

In some aspects, the techniques described herein relate to a system wherein the first document information comprises a first set of document attributes and the second document information comprises a second set of document attributes different than the first set of document attributes.

In some aspects, the techniques described herein relate to a system wherein the document version information identifies the hash function, the unique identifier generating function, and the encryption function.

In some aspects, the techniques described herein relate to a system wherein the instructions further cause the microprocessor to: generate a graphic representation based on the first QR code, the second QR code, and the third QR code; and encode the document with the graphic representation.

In some aspects, the techniques described herein relate to a system wherein the graphic representation comprises a rendering of a cube comprising a first surface comprising the first QR code, a second surface comprising the second QR code; and a third surface comprising the third QR code.

In some aspects, the techniques described herein relate to a system wherein the instructions further cause the microprocessor to: validate the document based on the encoded graphic representation, comprising: extract the second QR code from the second surface of the cube; regenerate the document version information from the second QR code comprising: identify a candidate hash function, a candidate unique identifier generating function, and a candidate encryption function; extract the first QR code from the first surface of the cube; generate a candidate hash code from the extracted first QR code; regenerate the document hash code based on the first document information and using the candidate hash function; extract the third QR code from the third surface of the cube; generate a candidate encryption hash code from the extracted third QR code; regenerate the unique identifier based on the second document information and the candidate unique identifier generating function; and regenerate an encrypted hash code based on the regenerated unique identifier and the regenerated document hash code using the candidate encryption function; wherein the document is validated based on a comparison of the candidate hash code and the regenerated hash code and a comparison of the candidate encryption hash code and the regenerated encryption hash code.

In some aspects, the techniques described herein relate to a non-transient computer readable medium having stored thereon instructions that cause a processor to execute a method for document encoding, the method comprising: receiving a document; generating a document hash code based on first document information and using a hash function; generating a first Quick Response (QR) code based on the document hash code; generating a unique identifier based on second document information and using a unique identifier generating function; generating an encrypted hash code based on the unique identifier and the document hash code using an encryption function; generating a second QR code based on document version information; and generating a third QR code based on the encrypted hash code.

In some aspects, the techniques described herein relate to a non-transient computer readable medium of claim 15, wherein the first document information comprises document attributes, the document attributes comprising document text and position of the document text.

In some aspects, the techniques described herein relate to a non-transient computer readable medium of claim 15, wherein the first document information comprises a first set of document attributes and the second document information comprises a second set of document attributes different than the first set of document attributes.

In some aspects, the techniques described herein relate to a non-transient computer readable medium of claim 15, further comprising: generating a graphic representation based on the first QR code, the second QR code, and the third QR code; and encoding the document with the graphic representation.

In some aspects, the techniques described herein relate to a non-transient computer readable medium of claim 18, wherein the graphic representation comprises a rendering of a cube comprising a first surface comprising the first QR code, a second surface comprising the second QR code; and a third surface comprising the third QR code.

In some aspects, the techniques described herein relate to a non-transient computer readable medium of claim 19, further comprising: validating the document based on the encoded graphic representation, comprising: extracting the second QR code from the second surface of the cube; regenerating the document version information from the second QR code comprising: identifying a candidate hash function, a candidate unique identifier generating function, and a candidate encryption function; extracting the first QR code from the first surface of the cube; generating a candidate hash code from the extracted first QR code; regenerating the document hash code based on the first document information and using the candidate hash function; extracting the third QR code from the third surface of the cube; generating a candidate encryption hash code from the extracted third QR code; regenerating the unique identifier based on the second document information and the candidate unique identifier generating function; and regenerating an encrypted hash code based on the regenerated unique identifier and the regenerated document hash code using the candidate encryption function; wherein validating the document is based on a comparison of the candidate hash code and the regenerated hash code and a comparison of the candidate encryption hash code and the regenerated encryption hash code.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 122(f) and/or Section 122, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a process in accordance with embodiments of the present disclosure;

FIG. 2 depicts a process in accordance with embodiments of the present disclosure;

FIG. 3 depicts a process in accordance with embodiments of the present disclosure;

FIG. 4 depicts a process in accordance with embodiments of the present disclosure;

FIG. 5 depicts a graphical element in accordance with embodiments of the present disclosure;

FIG. 6 depicts a document in accordance with embodiments of the present disclosure;

FIG. 7 depicts a data structure in accordance with embodiments of the present disclosure;

FIG. 8 depicts a data record in accordance with embodiments of the present disclosure;

FIG. 9 depicts a process in accordance with embodiments of the present disclosure;

FIG. 10 depicts a document in accordance with embodiments of the present disclosure;

FIG. 11 depicts a process in accordance with embodiments of the present disclosure;

FIG. 12 depicts a process in accordance with embodiments of the present disclosure; and

FIG. 13 depicts a device of a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

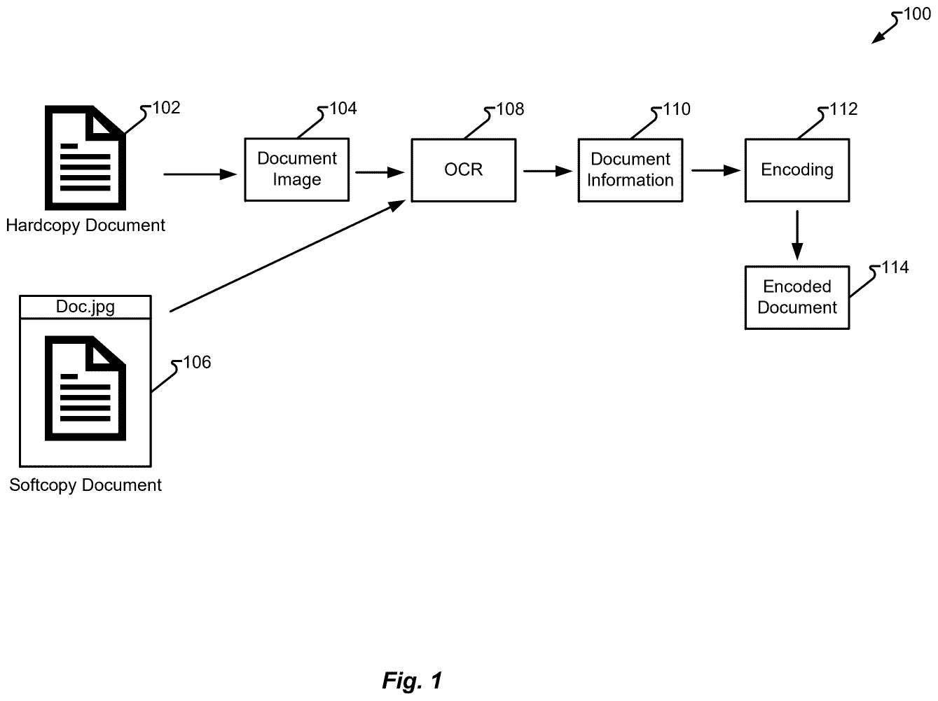

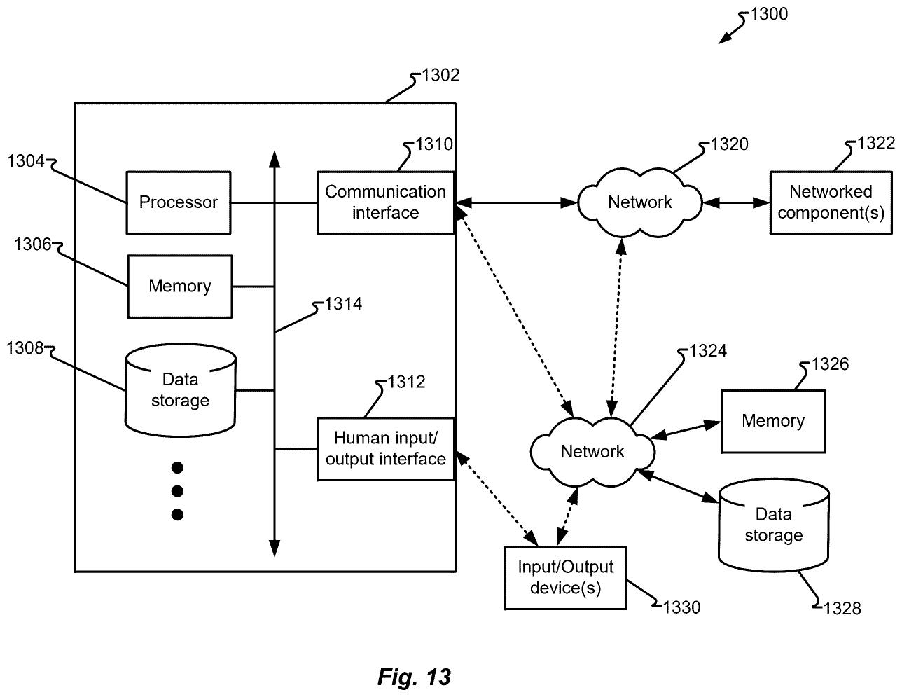

FIG. 1 depicts process 100 in accordance with embodiments of the present disclosure. In one embodiment, process 100 is embodied as machine-readable instructions maintained in a non-transitory memory that when read by a machine, such as processors of a server, cause the machine to execute the instructions and thereby execute process 100. The processor of the server may include, but is not limited to, at least one processor of device 1302 (see FIG. 13).

In one embodiment, process 100 takes a document and, from the document's content, produces a document comprising graphically-encoded document information. A document is created or accessed, such as hardcopy document 102, and is imaged to produce document image 104. Alternatively, an image of a document, such as softcopy document 106, may already exist, thereby allowing the imaging step to be omitted. Document image 104, or softcopy document 106, is then scanned with optical character recognition (OCR) 108 to produce document information 110.

Document information 110 is variously embodied and may include text characters, numbers, words, phrases, special characters (e.g., punctuation, mathematical operations, symbols, etc.), etc. and the location or position thereof. In one embodiment, every word of a document is used to create document information 110. In another embodiment, every character of a document is used to create document information 110. In another embodiment, non-zero but less than all words/characters are used to create the document information 110. For example, a document may have a thousand words, or alternatively a thousand numbers, and a shortened document information is obtained, such as from every third word, every fifth character, less than all numbers, all numbers but less than all non-numeric characters, text in a header, text in a footer, etc. As a benefit, data processing resources are conserved when the differences between an altered and unaltered document can be determined without the need to evaluate every word or character. In still another embodiment, graphical elements (e.g., logos, pictures, shapes, etc.) may be characterized and/or assigned a number and similarly evaluated to determine, in whole or in part, document information 110.

In another embodiment, certain embodiments herein rely on the document's content alone and omit consideration of the location or position of the content. As a benefit, data processing resources are conserved when the differences between an altered and unaltered document can be determined by the words/characters alone without regard to the specific location of the words/characters. In such embodiments, document information 110 may be obtained from the text of a document and imaging 104 and OCR 108 may be omitted or, if included, capturing and maintaining position information of the document's content may be omitted.

Document information 110 is then used by an encoding step to produce encoding 112. Encoding 112 may be or comprise a hash or other encoding derived from document information 110. Encoding 112 may comprise a numeric value (e.g., numeric, alphanumeric, hexadecimal, etc.) that may then be applied to create encoded document 114. As will be discussed in more detail below, encoding used to produce encoding 112 may further produce a symbolic representation (e.g., a QR code) of the numeric value. The resulting encoded document 114 then comprises the original document content (e.g., the visual elements present on hardcopy document 102 and/or softcopy document 106) and the symbolic representation (or numeric value). Application of the symbolic representation is applied so as to not overlay or obscure any of the document content used for generating the symbolic representation. In another embodiment, if application of the symbolic representation requires a portion of the document content of encoded document 114 to be obscured, portions of process 100 may be performed that exclude those portions of document information 110 that will be overlayed or obscured by the symbolic representation.

Symbolic representations used herein allow for a machine to read and process the content encoded by the symbolic representation. Additionally, manual alteration (e.g., with a pen or pencil) of a symbolic representation already applied to a document is essentially impossible, even if one knew how the symbolic representation should look, as any change would require the removal and addition of encoding symbols of the symbolic representation.

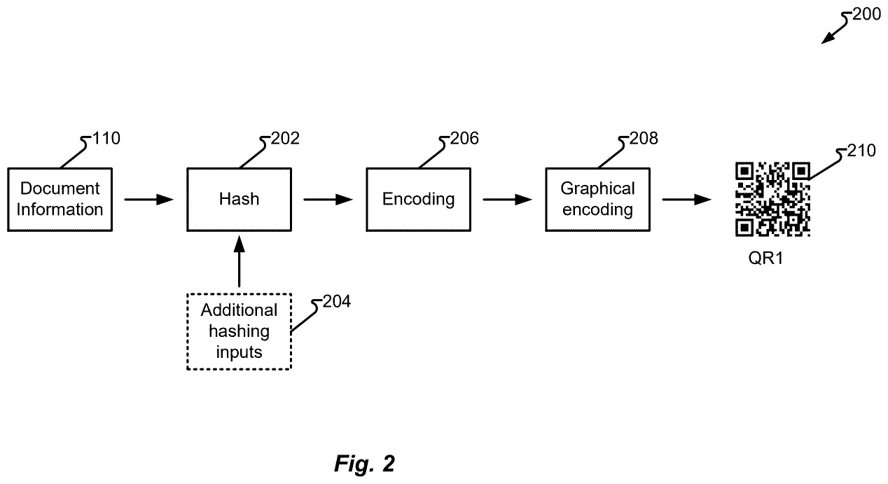

FIG. 2 depicts process 200 in accordance with embodiments of the present disclosure. In one embodiment, process 200 is embodied as machine-readable instructions maintained in a non-transitory memory that when read by a machine, such as processors of a server, cause the machine to execute the instructions and thereby execute process 200. The processor of the server may include, but is not limited to, at least one processor of device 1302 (see FIG. 13).

In one embodiment, document information 110 is utilized to generate hash 202.

Optionally, additional hashing inputs 204 may include any other parameter or data utilized by a hashing algorithm (e.g., SHA-512) such as a seed, temporal information, etc. Graphical encoding 206 results, such as the hash itself, which may then be converted to a graphic by graphical encoded 208 and applied to encoded document 114 or further processed to generate symbolic representation 210, such as a QR code.

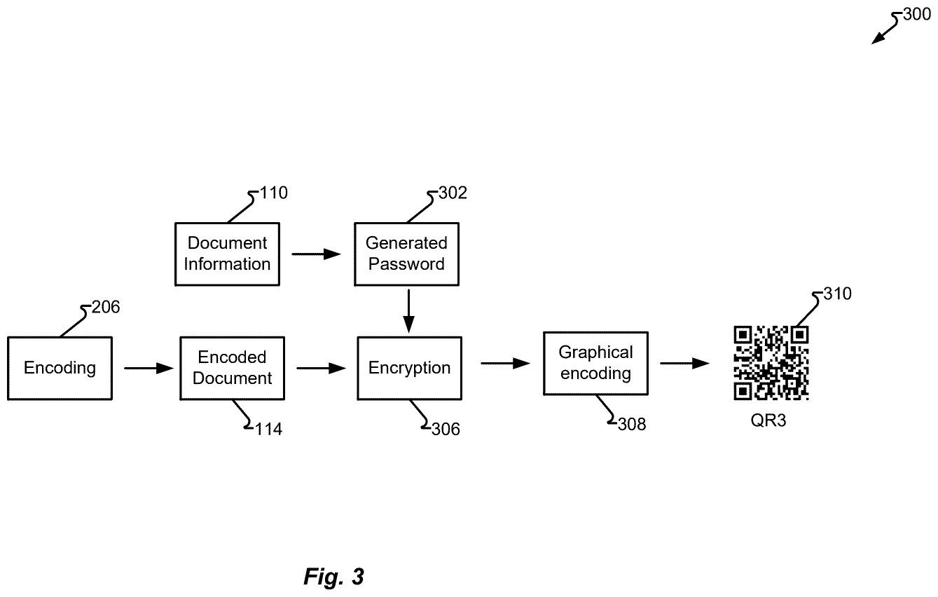

FIG. 3 depicts a process 300 in accordance with embodiments of the present disclosure. In one embodiment, process 300 is embodied as machine-readable instructions maintained in a non-transitory memory that when read by a machine, such as processors of a server, cause the machine to execute the instructions and thereby execute process 300. The processor of the server may include, but is not limited to, at least one processor of device 1302 (see FIG. 13).

In one embodiment, document information 110 is provided to a password generation algorithm (e.g., AES-256) to produce generated password 302. Additionally or alternatively, the password generation algorithm may be provided as a salt. Encoding 206 (see FIG. 2) used to generate encoding 206 (Id.) or encoding 112 (see FIG. 1), with generated password 302, is used to create encryption 306. Encryption 306 is then applied to encoded document 114 (see FIG. 1) or further processed by graphical encoding 308 to generate symbolic representation 310 (e.g., a QR code).

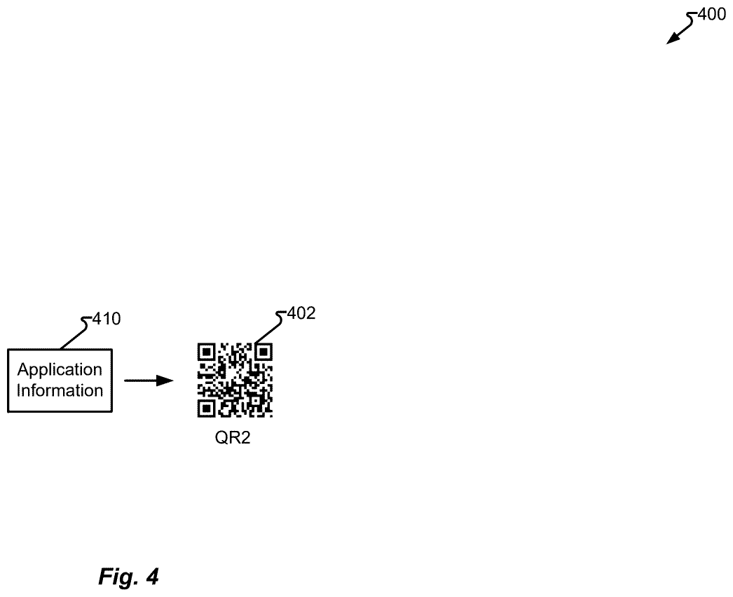

FIG. 4 depicts a process 400 in accordance with embodiments of the present disclosure. In one embodiment, process 400 is embodied as machine-readable instructions maintained in a non-transitory memory that when read by a machine, such as processors of a server, cause the machine to execute the instructions and thereby execute process 400. The processor of the server may include, but is not limited to, at least one processor of device 1302 (see FIG. 13).

The particular encoding and/or symbolic representation applied to a document may be dependent on the particular methodology used to generate the encoding or symbolic representation. Accordingly, the application utilized to produce encoding 112 or encoding 206, such as the particular algorithm, software, version thereof, etc., is identified and applied to encoded document 114. The identification may further be encoded as symbolic representation 402 (e.g., a QR code).

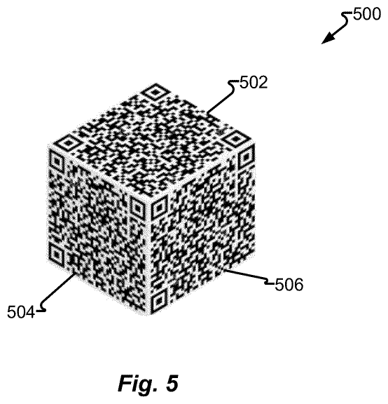

FIG. 5 depicts graphical element 500 in accordance with embodiments of the present disclosure. In one embodiment, a plurality of symbolic representations are combined as single graphically-encoded document information. Graphical element 500 is embodied as a cube or at least a two-dimensional representation of a cube having facet 502, facet 504, and facet 506 displayed as a skewed QR code. For example, facet 502 may comprise a skewed version of symbolic representation 210 (e.g., QR code 1), facet 504 may comprise a skewed version of symbolic representation 310 (e.g., QR code 3), and facet 506 may comprise a skewed version of symbolic representation 402 (e.g., QR code 2). One benefit of graphical element 500 is a machine-vision system may readily identify on a document.

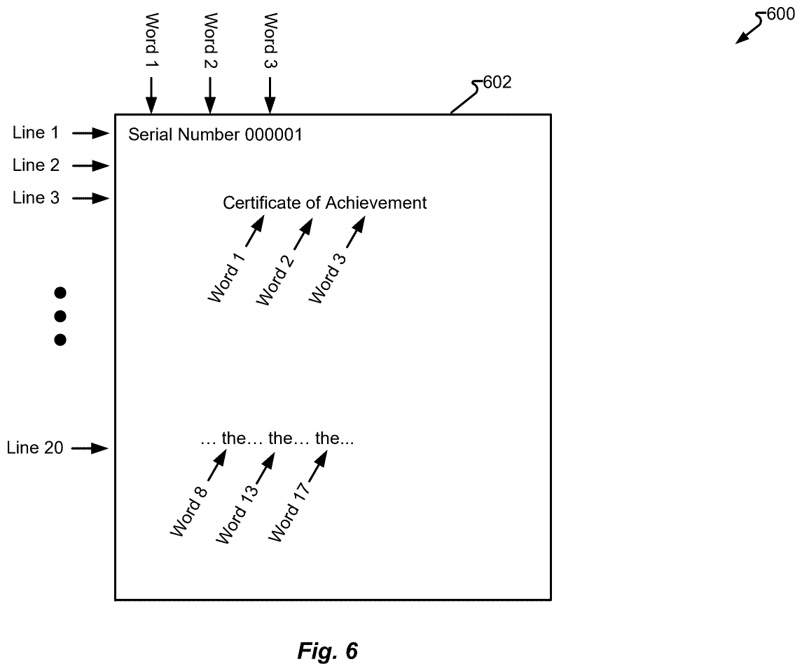

FIG. 6 depicts document 600 in accordance with embodiments of the present disclosure. Generating document information 110 (see FIG. 1) is variously embodied. In one embodiment, document 602 comprises textual information (e.g., characters, words, numbers, special symbols, etc.). In a further embodiment, the textual information and the position (e.g., line number, word number, x-y pixel position, x-y distance, etc.) of the textual information is obtained and comprises document information 110. A data record may then be produced with the document information (see FIG. 8, below) and, therefrom encoding 112 (see FIG. 1) determined.

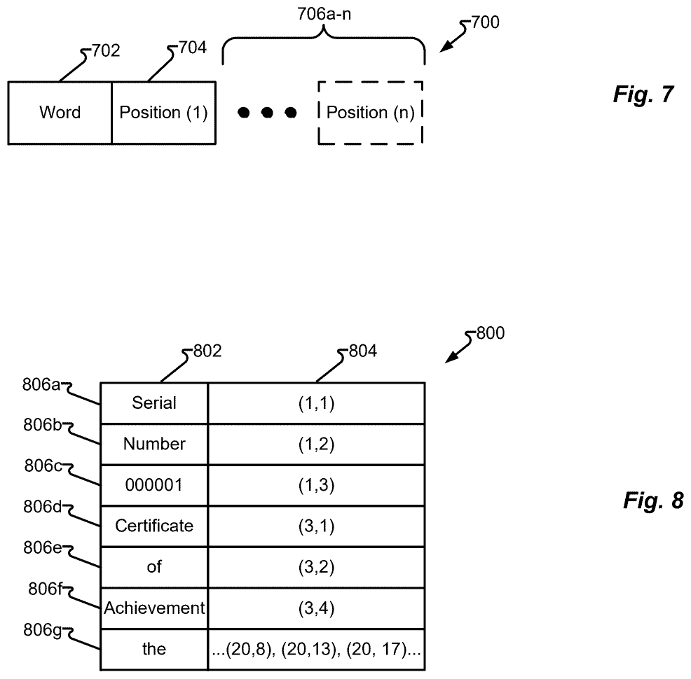

FIG. 7 depicts data structure 700 in accordance with embodiments of the present disclosure. In one embodiment, data structure 700 comprises a number of data fields including word data field 702 for the storage of words and/or numbers, character groups, phrases, etc. and first position data field 704 identifying the first location in a document, such as document 600 (see FIG. 6), where the word (etc.) is located. Optionally, additional position data fields 706a-n identify the subsequent occurrences of the word (etc.) in the document. As a further embodiment, first position data field 704 may comprise values incorporating each position and thereby merge first position data field 704 with additional position data fields 706a-n.

FIG. 8 depicts data record 800 in accordance with embodiments of the present disclosure. In one embodiment, field 802 corresponds to word data field 702 (see FIG. 7), locations 604 corresponding to position data fields 706a-n (see FIG. 7), and records 806a-806g correspond to a merged position data field (e.g., word data field 702 merged with additional position data fields 706a-n).

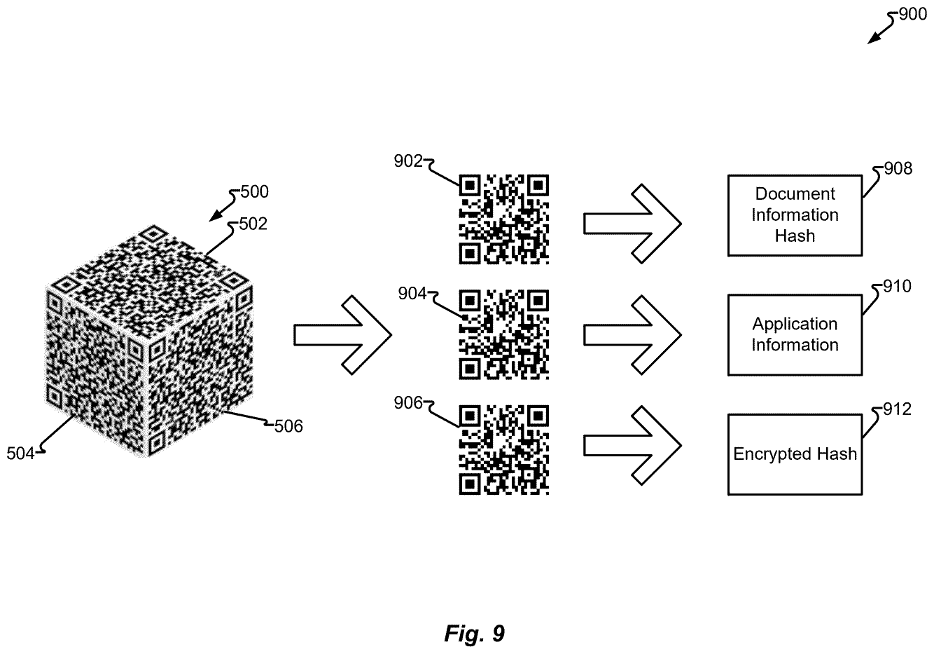

FIG. 9 depicts process 900 in accordance with embodiments of the present disclosure. In one embodiment, process 100 is embodied as machine-readable instructions maintained in a non-transitory memory that when read by a machine, such as processors of a server, cause the machine to execute the instructions and thereby execute process 100. The processor of the server may include, but is not limited to, at least one processor of device 1302 (see FIG. 13).

In one embodiment, graphical element 500 is applied to a document and a determination is to be made whether or not the content of the document has been altered. Accordingly, the document is imaged and, therefrom, graphical element 500 is segmented and de-skewed to create symbolic representation 902, symbolic representation 904, and symbolic representation 906. In turn, document information hash 908 is derived from symbolic representation 902, application information 910 is derived from symbolic representation 904, and encrypted hash 912 is derived from symbolic representation 906.

With the reported document information (e.g., document information hash 908, application information 910, and encrypted hash 912) obtained from the document itself, the content of the document may be processed to derive document information. If the reported document information matches the derived document information, the content of the document has not been altered.

In accordance with embodiments of the present disclosure and referring again to FIG. 1, document alteration is detected using document encoding information unique to each document. The document encoding information is applied to the document, meaning that the document encoding forms a portion of the document. In this way, and advantageously, the document encoding may be extracted from the document and along with document information used to derive candidate document encoding information.

If such candidate document encoding information matches the extracted document encoding information, then the document may be determined as valid and/or unaltered. This is because if the document were to be altered and/or tampered with, such as by a malicious actor or process or even unintentionally where differences are an important consideration in document archiving, migrating and/or similar operations, the candidate document encoding information would not match the extracted document encoding information, as will be explained in detail hereinbelow.

Document encoding comprises receiving a document, such as in hard copy 102 or soft copy format 106 as shown in FIG. 1. Referring to FIG. 2., a document hash code (206) is generated based on first document information 101 and using a hash function. In some embodiments, first document information comprises document attributes such as document text and position of the document text. One of ordinary skill in the art will realize that first document information may include many different document attributes (110 or a combination of 110 and 204) if such document attributes portray the document. Furthermore, a variety of hash functions may be used to generate the hash code, including but not limited to the SHA-512 hash function. A first Quick Response (QR) code is generated based on the document hash code.

Referring to FIG. 3, a unique identifier (302) is generated based on second document information (110) and using a unique identifier generating function. Unique identifier serves to uniquely identify the document. In some embodiments, the second document information includes a string formed by concatenating all special characters in the document, a string formed by concatenating all numbers in the document, a string formed by concatenating every 4th letter (or nth letter) in the document, a string formed by concatenating combination of special characters and numbers, a string from critical data like vendor name, total amount etc. based on a defined document template is already defined, and/or an algorithm which generates short word from the document. The unique identifier generating function uses the second document information to generate the unique identifier.

Moreover, an encrypted hash code is generated based on the unique identifier and the document hash code using an encryption function. A variety of encryption functions may be used including, but not limited to, Triple DES (3DES), Advanced Encryption Standard (AES), etc. Another QR code (hereinafter referred to as a third QR code) is generated based on the encrypted hash code. Advantageously, use of encryption enhances the document encoding security.

A second QR code is generated based on document version information. In some embodiments, the document version information identifies the hash function, the unique identifier generating function and the encryption function. In still other embodiments, the document version information includes the first document information used to generate the first QR code and/or the second document information used to generate the third QR code.

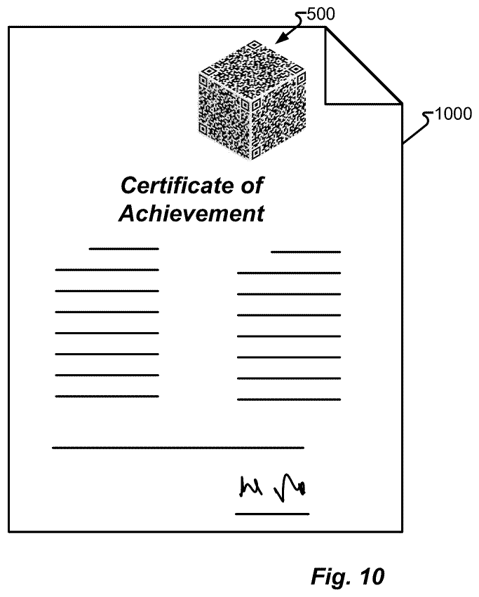

In some embodiments, a graphic representation is generated based on the first QR code, the second QR code, and the third QR code and the document is encoded with the graphic representation (a nonlimiting example of which is portrayed in FIG. 10). Referring to FIG. 5, in further embodiments, the graphic representation comprises a rendering of a cube 500 comprising a first surface 502 comprising the first QR code, a second surface 504 comprising the third QR code; and a third surface 506 comprising the second QR code. In such embodiments, and as described in the present disclosure, a QR cube uniquely identifies a document. As described in the present disclosure, QR codes are generated via a combination of document information and attributes therein, a password that uniquely identifies the document, a hash code that further uniquely identifies the document, and encryption that further uniquely identifies the document and adds a layer of security to the encoding. Furthermore, a QR code encapsulates document versioning information that dictates during document validation how to generate the QR codes for the document.

In further embodiments, a different graphical representation may be generated and applied to each page of a multi-page document. Each page's graphical representation may be based on the page's attributes. In a different embodiment, a single graphical representation may be generated, such as for a cover sheet of a multi-page document, and applied to each page.

According to embodiments of the present disclosure and referring to FIG. 5, the document is validated based on the encoded graphic representation 500, comprising extracting the second QR code from the third surface 506 of the cube and regenerating the document version information from the second QR code comprising identifying a candidate hash function, a candidate unique identifier generating function, and a candidate encryption function.

The first QR code is extracted from the first surface 502 of the cube and a candidate hash code from is generated from the extracted first QR code. The document hash code is regenerated based on the first document information and using the candidate hash function.

The third QR code is extracted from the second surface 504 of the cube and a candidate encryption hash code is generated from the extracted third QR code. The unique identifier is regenerated based on the second document information and the candidate unique identifier generating function. The encrypted hash code is regenerated based on the regenerated unique identifier and the regenerated document hash code using the candidate encryption function.

Moreover, validating the document is based on a comparison of the candidate hash code and the regenerated hash code and a comparison of the candidate encryption hash code and the regenerated encryption hash code. In further embodiments, the document is determined to be valid (i.e., unaltered, or untampered with) if the candidate hash code matches the regenerated hash code and the candidate encryption hash code matches regenerated encryption hash code.

FIG. 10 depicts document 1000 in accordance with embodiments of the present disclosure. In one embodiment, document 1000 comprises text and/or other markings and graphical element 500.

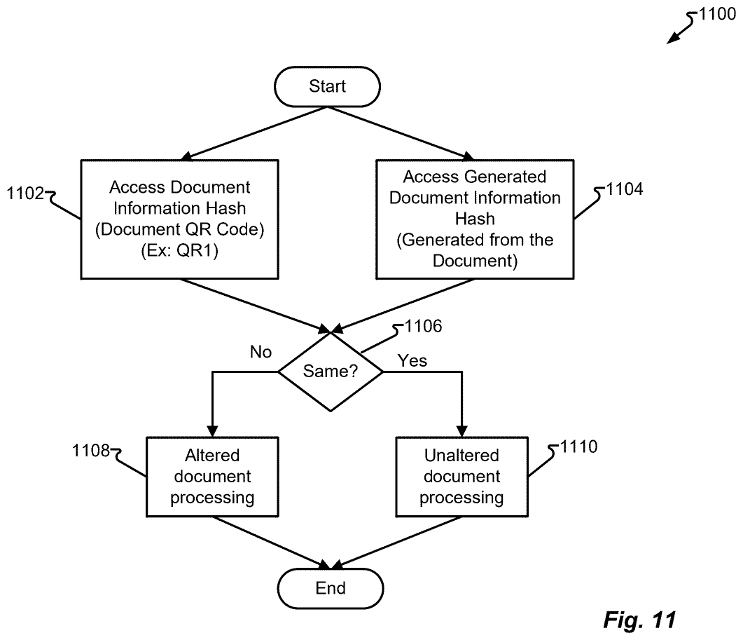

FIG. 11 depicts process 1100 in accordance with embodiments of the present disclosure. In one embodiment, process 1100 is embodied as machine-readable instructions maintained in a non-transitory memory that when read by a machine, such as processors of a server, cause the machine to execute the instructions and thereby execute process 1100. The processor of the server may include, but is not limited to, at least one processor of device 1302 (see FIG. 13).

In one embodiment, process 1100 begins and in step 1102 accesses encrypted document information hash from the image of a document. The encrypted document information hash may be a numeric value or an encoded numeric value, such as symbolic representation (e.g., a QR code). Step 1104, using the document content of the document, accesses a generated encrypted numeric value, such as a generated encrypted document information hash. Optionally, accessing the generated encrypted numeric value comprises generating the generated encrypted numeric value. Step 1104 may utilize application information obtained from the document (e.g., symbolic representation 402). Test 1106 determines if the resulting encrypted document information hash and generated encrypted document information hash are the same.

If test 1106 is determined in the affirmative, processing continues to step 1110, wherein the document is processed as unaltered. If test 1106 is determined in the negative, processing continues to step 1108, wherein the document is processed as altered. One or both of steps 1108 and 1110 may include creating a data record in a computer storage device associated with the document and indicating the document is altered or unaltered, respectively.

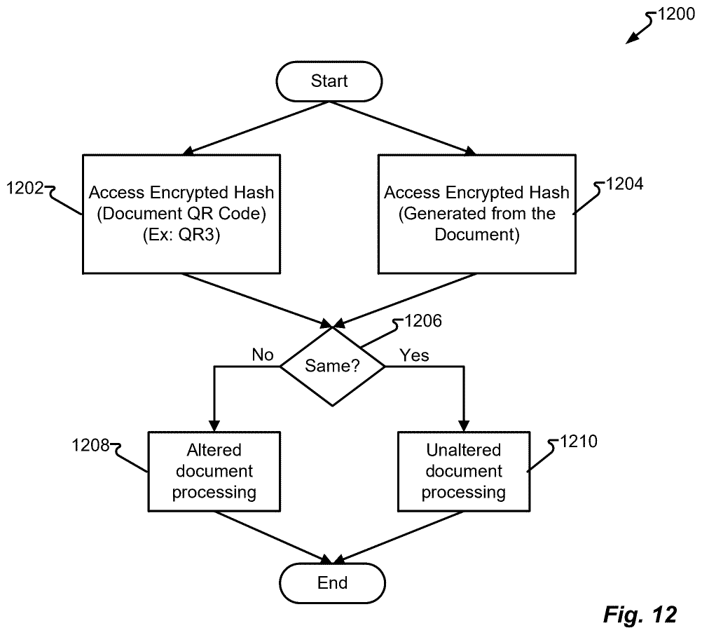

FIG. 12 depicts process 1200 in accordance with embodiments of the present disclosure. In one embodiment, process 1200 is embodied as machine-readable instructions maintained in a non-transitory memory that when read by a machine, such as processors of a server, cause the machine to execute the instructions and thereby execute process 1200. The processor of the server may include, but is not limited to, at least one processor of device 1302 (see FIG. 13).

In one embodiment, process 1200 begins and in step 1202 accesses encrypted hash from the image of a document. The encrypted hash may be a numeric value or an encoded numeric value, such as symbolic representation (e.g., a QR code). Step 1204, using the document content of the document, accesses a generated encrypted numeric value, such as a generated encrypted hash. Optionally, accessing the generated encrypted numeric value comprises generating the generated encrypted numeric value. Step 1204 may utilize application information obtained from the document (e.g., symbolic representation 402). Test 1206 determines if the resulting encrypted hash and generated encrypted hash are the same.

If test 1206 is determined in the affirmative, processing continues to step 1210, wherein the document is processed as unaltered. If test 1206 is determined in the negative, processing continues to step 1208, wherein the document is processed as altered. One or both of steps 1208 and 1210 may include creating a data record in a computer storage device associated with the document and indicating the document is altered or unaltered, respectively.

FIG. 13 depicts a device 1302 of system 1300 in accordance with embodiments of the present disclosure. In one embodiment, device 1302 comprises various components and connections to other components and/or systems. The components are variously embodied and may comprise processor 1304. The term “processor,” as used herein, refers exclusively to electronic hardware components comprising electrical circuitry with connections (e.g., pin-outs) to convey encoded electrical signals to and from the electrical circuitry. Processor 1304 may comprise programmable logic functionality, such as determined, at least in part, from accessing machine-readable instructions maintained in a non-transitory data storage, which may be embodied as circuitry, on-chip read-only memory, computer memory 1306, data storage 1308, etc., that cause the processor 1304 to perform the steps of the instructions. Processor 1304 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 1314, executes instructions, and outputs data, again such as via bus 1314. In other embodiments, processor 1304 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 1304 is a non-transitory computing device (e.g., electronic machine comprising circuitry and connections to communicate with other components and devices). Processor 1304 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 1304). Processor 1304 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 1304, device 1302 may utilize computer memory 1306 and/or data storage 1308 for the storage of accessible data, such as instructions, values, etc. Communication interface 1310 facilitates communication with components, such as processor 1304 via bus 1314 with components not accessible via bus 1314 and may be embodied as a network interface (e.g., ethernet card, wireless networking components, USB port, etc.). Communication interface 1310 may be embodied as a network port, card, cable, or other configured hardware device. Additionally or alternatively, human input/output interface 1312 connects to one or more interface components to receive and/or present information (e.g., instructions, data, values, etc.) to and/or from a human and/or electronic device. Examples of input/output devices 1330 that may be connected to input/output interface include, but are not limited to, keyboard, mouse, trackball, printers, displays, sensor, switch, relay, speaker, microphone, still and/or video camera, etc. In another embodiment, communication interface 1310 may comprise, or be comprised by, human input/output interface 1312. Communication interface 1310 may be configured to communicate directly with a networked component or configured to utilize one or more networks, such as network 1320 and/or network 1324.

Network 1320 may be a wired network (e.g., Ethernet), wireless (e.g., WiFi, Bluetooth, cellular, etc.) network, or combination thereof and enable device 1302 to communicate with networked component(s) 1322. In other embodiments, network 1320 may be embodied, in whole or in part, as a telephony network (e.g., public switched telephone network (PSTN), private branch exchange (PBX), cellular telephony network, etc.).

Additionally or alternatively, one or more other networks may be utilized. For example, network 1324 may represent a second network, which may facilitate communication with components utilized by device 1302. For example, network 1324 may be an internal network to a business entity or other organization, whereby components are trusted (or at least more so) than networked components 1322, which may be connected to network 1320 comprising a public network (e.g., Internet) that may not be as trusted.

Components attached to network 1324 may include computer memory 1326, data storage 1328, input/output device(s) 1330, and/or other components that may be accessible to processor 1304. For example, computer memory 1326 and/or data storage 1328 may supplement or supplant computer memory 1306 and/or data storage 1308 entirely or for a particular task or purpose. As another example, computer memory 1326 and/or data storage 1328 may be an external data repository (e.g., server farm, array, “cloud,” etc.) and enable device 1302, and/or other devices, to access data thereon. Similarly, input/output device(s) 1330 may be accessed by processor 1304 via human input/output interface 1312 and/or via communication interface 1310 either directly, via network 1324, via network 1320 alone (not shown), or via networks 1324 and 1320. Each of computer memory 1306, data storage 1308, computer memory 1326, data storage 1328 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 1330 may be a router, a switch, a port, or other communication component such that a particular output of processor 1304 enables (or disables) input/output device 1330, which may be associated with network 1320 and/or network 1324, to allow (or disallow) communications between two or more nodes on network 1320 and/or network 1324. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method of determining document alteration, comprising:
imaging a document, the document comprising document content and graphically-encoded document information;
decoding the graphically-encoded document information to obtain reported textually-encoded document information;
encoding the document content to produce derived textually-encoded document information; and
upon determining that the reported textually-encoded document information matches the derived textually-encoded document information, identifying the document as unaltered, and upon determining that the reported textually-encoded document information differs from the derived textually-encoded document information, identifying the document as altered.

2. The method of claim 1, wherein the graphically-encoded document information comprises a machine-readable set of geometric elements that graphically encode the reported textually-encoded document information.

3. The method of claim 1, wherein the reported textually-encoded document information encodes at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

4. The method of claim 1, wherein encoding the document content to produce the derived textually-encoded document information comprises encoding at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

5. The method of claim 4, wherein the at least one of characters of the document content comprises a Unicode character.

6. The method of claim 1, wherein the graphically-encoded document information comprises a first Quick Response (QR) code.

7. The method of claim 6, wherein:
the graphically-encoded document information further comprises a second Quick Response (QR) code and a third Quick Response (QR) code; and
wherein the second QR code comprises an encoded hash of the first QR code; and
wherein the third QR code comprises an identifier of an encoding method used to generate the first QR code from the document content.

8. The method of claim 7, wherein:
the graphically-encoded document information comprises a two-dimensional rendering of a cube comprising a first facet, a second facet, and a third facet;
the first facet comprises a skewed image of the first QR code;
the second facet comprises a skewed image of the second QR code; and
the third facet comprises a skewed image of the third QR code.

9. The method of claim 1, wherein the document is a physical document.

10. A system, comprising:
a microprocessor; and
a computer readable medium, coupled with the microprocessor and comprising microprocessor readable and executable instructions that, when executed by the microprocessor, cause the microprocessor to:
access an image of a document captured by a camera, the document comprising document content and graphically-encoded document information;
decode the graphically-encoded document information to obtain reported textually-encoded document information;
encode the document content to produce derived textually-encoded document information; and
upon determining that the reported textually-encoded document information matches the derived textually-encoded document information, identify the document as unaltered, and upon determining that the reported textually-encoded document information differs from the derived textually-encoded document information, identify the document as altered.

11. The system of claim 10, wherein the graphically-encoded document information comprises a machine-readable set of geometric elements that graphically encode the reported textually-encoded document information.

12. The system of claim 10, wherein the reported textually-encoded document information encodes at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

13. The system of claim 10, wherein the instructions to cause the microprocessor to encode the document content to produce the derived textually-encoded document information comprise instructions to cause the microprocessor to encode at least one of characters of the document content, character-location pairs of the document content, words of the document content, word-location pairs of the document content, numbers of the document content, number-location pairs of the document content, symbols of the document content, symbol-location pairs of the document content, or any one or more of the foregoing within a previously determined portion of the document content.

14. The system of claim 13, wherein the at least one of characters of the document content comprises a Unicode character.

15. The system of claim 10, wherein the graphically-encoded document information comprises a first Quick Response (QR) code.

16. The system of claim 15, wherein:
the graphically-encoded document information further comprises a second Quick Response (QR) code and a third Quick Response (QR) code; and
wherein the second QR code comprises an encoded hash of the first QR code; and
wherein the third QR code comprises an identifier of an encoding method used to generate the first QR code from the document content.

17. The system of claim 16, wherein:
the graphically-encoded document information comprises a two-dimensional rendering of a cube comprising a first facet, a second facet, and a third facet;
the first facet comprises a skewed image of the first QR code;
the second facet comprises a skewed image of the second QR code; and
the third facet comprises a skewed image of the third QR code.

18. The system of claim 10, wherein the document is a physical document.

19. A non-transient computer readable medium having stored thereon instructions that cause a processor to execute a method, the method comprising:
accessing an image of a document, the document comprising document content and graphically-encoded document information;
decoding the graphically-encoded document information to obtain reported textually-encoded document information;
encoding the document content to produce derived textually-encoded document information; and
upon determining that the reported textually-encoded document information matches the derived textually-encoded document information, identifying the document as unaltered, and upon determining that the reported textually-encoded document information differs from the derived textually-encoded document information, identifying the document as altered.

20. The non-transient computer readable medium of claim 19, wherein accessing the image of the document comprises receiving the image of the document from a camera.
